(19) United States
(12) Patent Application Publication
(10) Pub. No.: US 2010/0098782 A1
(43) Pub. Date: Apr. 22, 2010

(54) USE OF SODIUM ACID SULFATE AS A DISINFECTANT

(75) Inventor: Michael F. Coughlin, Cincinnati, OH (US)

Correspondence Address: JohnsonDiversey, Inc., 8310 16TH STREET, M/S 509, PO BOX 902, STURTEVANT, WI, 53177-0902, US

(73) Assignee: JOHNSONDIVERSEY, INC., Sturtevant, WI (US)

(21) Appl. No.: 12/575,901

(22) Filed: Oct. 8, 2009

Related U.S. Application Data
(60) Provisional application No. 61/106,061, filed on Oct. 16, 2008.

(51) Int. Cl. A01N 59/02; A01P 1/00

(52) U.S. Cl. 424/709

(57) ABSTRACT

Animal carcasses are disinfected by applying to the animal carcass an aqueous solution of sodium acid sulfate that does not include a chlorine-containing composition. The solution is maintained at from about pH 1.0 to about pH 2.5 and can optionally include a second acid such as citric acid, lactic acid, or combinations thereof.

### BACKGROUND OF THE INVENTION

Animal carcasses intended for food use are generally treated with a disinfectant. A wide variety of disinfectants have been used. Chlorine has been used as a sterilizing and sanitizing agent. This has been applied as a gas or as an aqueous solution of a chlorine-containing compound. In particular, acidified solutions of chlorites, as well as acidified solutions of chlorous acid or chlorine dioxide, have been used as topical antibacterial agents. Warf, Jr. et al. pending application 2007/0042094 discloses the use of a blend of sodium acid sulfate and a metal chlorite for use in disinfecting carcasses. Sodium acid sulfate has also been used in combination with solutions of chlorine dioxide to disinfect carcasses. In both of these applications, the sodium acid sulfate is used purely to convert the metal chlorite to ClO₂ and/or chlorous acid, and is not disclosed to have any disinfecting capability.

### SUMMARY OF THE INVENTION

The present invention is premised on the realization that sodium acid sulfate can be used by itself without a chlorine generating compound such as a metal chlorite or chlorine dioxide to disinfect animal carcasses. In particular, sodium acid sulfate disinfects carcass surfaces between about pH 1.5-2.5. Inorganic acids may be added as buffers.

Further, the sodium acid sulfate can be used by itself for direct food contact disinfection without the addition of any other antibacterial agents in many different applications.

The solutions of sodium acid sulfate (SAS) are less corrosive than mineral acids and do not fume. Further, SAS has a lower pH than phosphoric acid and does not contribute to eutrophication of lakes and streams. It is particularly suited for disinfecting vegetables and fruits, including lettuce and spinach.

The objects and advantages of the present invention will be further appreciated in light of the following detailed description and drawings.

### DETAILED DESCRIPTION

According to the present invention, an aqueous solution of sodium acid sulfate is used as a surface disinfectant particularly suitable for direct food contact. In one particular application, the sodium acid sulfate is used as a disinfectant for animal carcasses, and, in particular, poultry.

In the preparation of animal carcasses for consumption, the carcass is cleaned and all feathers are removed from poultry. With respect to mammals, the hide is generally removed. Then, either prior to butchering or subsequent to butchering, the animal carcass is treated with a disinfecting solution intended to reduce the amount of bacteria present on the animal carcass. The disinfecting solution is an aqueous solution of sodium acid sulfate having a pH of 1.5 to 2.5, with typically about 2.0.

Sodium acid sulfate can be applied using typical carcass treatment apparatus. The SAS solution can be applied either as a spray or in a dip tank to contact the carcass with the solution for a period of a few seconds up to several minutes, typically 1 to 30 seconds.

The disinfecting solution is substantially free of chlorine-generating compositions, metal chlorites, chlorine dioxide, chlorous acid, or the like. “Substantially free” means that the concentration of any chlorine-containing compound in the solution is so low it has no significant disinfecting property. Generally, chlorine dioxide will not exhibit a significant antimicrobial effect at less than 0.1 ppm. Further, the composition will generally not contain any salt, such as sodium chloride, in a concentration that would have antimicrobial properties.

The disinfecting solution is applied to the animal carcass at room temperature, about 22° C.

The aqueous solution of sodium acid sulfate is formed simply by dissolving solid sodium acid sulfate in water. The actual use concentration of the sodium acid sulfate may be from about 2000 to about 10,000 ppm, depending upon the particular application. The cleaning solution should be less than pH 2.5 and, preferably, less than about pH 2.25.

Depending upon the concentration of the sodium acid sulfate in the solution, the desired pH can be achieved by adding either a mineral base such as sodium hydroxide to raise the pH. With lower concentrations of sodium acid sulfate, inorganic or organic acids such as citric acid, lactic acid, tartaric acid, or even hydrochloric acid, can be added to lower the pH and provide pH buffering capacity.

In addition to the SAS and any optional acid, the disinfecting solution can include a wetting agent, generally an anionic or nonionic GRAS listed surfactant. In particular, 0.5% of sodium dodecyl sulfate (use concentration) is suitable as a wetting agent. In addition to cleaning animal carcasses, the disinfecting solution can be used to clean a variety of different surfaces, such as fruits and vegetables, and food processing equipment. This is particularly beneficial because the SAS solution does not adversely affect the taste of the food. This invention will be further appreciated in light of the following detailed examples.

### Example 1

The germicidal effectiveness of 4000 ppm of sodium acid sulfate was tested at various levels of pH. The pH of the solutions was adjusted by addition of sodium hydroxide. The test method was A Modification of the Germicidal and Detergent Sanitizing Action of Disinfectants, A.O.A.C., 17^{th} Edition 2000. The test organism was Escherichia coli, ATCC #11229 (560,000 org/ml), which was contacted with the sodium acid sulfate for 10 seconds and 30 seconds at 25° C. The recovery medium was Tryptone Glucose Extract Agar with Asolectin and Tween 80. Phosphate Buffer 0.2M was employed. The results in terms of organisms per milliliter are shown in Table 1.

TABLE 1

| | 10 Seconds Contact | | 30 Seconds Contact | |
|---|---|---|---|---|
| | Survivors | | Survivors | |
| pH | (org/ml) | % Reduction | (org/ml) | % Reduction |
| 1.49 | 43,000,000 | 92.321 | 40,300,000 | 92.804 |
| 1.59 | 63,300,000 | 88.696 | 57,500,000 | 89.732 |
| 1.70 | 51,800,000 | 90.750 | 46,000,000 | 91.785 |
| 1.79 | 43,000,000 | 92.321 | 34,500,000 | 93.839 |
| 1.89 | 40,300,000 | 92.804 | 31,500,000 | 94.375 |
| 1.99 | 175,000,000 | 68.750 | 102,000,000 | 81.785 |
| 2.11 | 103,000,000 | 81.607 | 96,000,000 | 82.857 |
| 2.18 | 115,000,000 | 79.464 | 107,000,000 | 98.089 |
| 2.29 | 105,000,000 | 81.250 | 77,000,000 | 86.250 |
| 2.39 | 133,000,000 | 76.250 | 128,000,000 | 77.142 |
| 2.49 | 159,000,000 | 71.607 | 156,000,000 | 72.142 |

### Example 2

In order to determine the antimicrobial effectiveness of the present invention, Salmonella enteriditis at 120,000,000 organisms per milliliter was contacted for 30 seconds, 1 minute, or 2 minutes, with 2,000 ppm SAS, or 4,000 ppm SAS at the indicated pH. The neutralizer was 0.2M Phosphate Buffer, pH 7.0, and the growth medium was 3M Aerobic Count Petrifilm using an incubation time of 4 days at 35° C. The results are shown in Tables 2 and 3.

TABLE 2

| | | 30 Seconds Contact | | 1 Minute Contact | | 2 Minutes Contact | |
|---|---|---|---|---|---|---|---|
| | | Survivors | % | Survivors | % | Survivors | % |
| Product | pH | (org/ml) | Reduction | (org/ml) | Reduction | (org/ml) | Reduction |
| 4000 ppm | 1.5 | 4,600,000 | 96.167 | 7,000 | 99.994 | 60 | >99.999 |
| SAS | | 8,600,000 | 92.833 | 29,000 | 99.976 | 4,000 | 99.997 |
| | 1.75 | 6,900,000 | 94.250 | 4,000,000 | 96.667 | 700,000 | 98.933 |
| | | 8,500,000 | 92.917 | 1,900,000 | 98.417 | 1,400,000 | 98.833 |
| | 2.0 | 20,100,000 | 83.250 | 6,500,000 | 94.583 | 4,600,000 | 96.167 |
| | | 18,600,000 | 84.500 | 2,600,000 | 97.833 | 10,300,000 | 91.417 |
| | 2.25 | >25,000,000 | <79.167 | >25,000,000 | <79.167 | >25,000,000 | <79.167 |
| | | >25,000,000 | <79.167 | >25,000,000 | <79.167 | >25,000,000 | <79.167 |
| | 2.5 | >25,000,000 | <79.167 | >25,000,000 | <79.167 | >25,000,000 | <79.167 |
| | | >25,000,000 | <79.167 | >25,000,000 | <79.167 | >25,000,000 | <79.167 |

TABLE 3

| | | 30 Seconds Contact | | 1 Minute Contact | | 2 Minutes Contact | |
|---|---|---|---|---|---|---|---|
| | | Survivors | % | Survivors | % | Survivors | % |
| Product | pH | (org/ml) | Reduction | (org/ml) | Reduction | (org/ml) | Reduction |
| 2000 ppm | 1.5 | 11,700,000 | 90.250 | 46,000 | 99.962 | 10 | >99.999 |
| SAS | | 17,700,000 | 85.250 | 21,000 | 99.983 | 20 | >99.999 |
| | 1.75 | >25,000,000 | <79.167 | >25,000,000 | <97.917 | 970,000 | 98.192 |
| | | >25,000,000 | <79.167 | >25,000,000 | <97.917 | 220,000 | 98.817 |
| | 2.0 | >25,000,000 | <79.167 | >25,000,000 | <97.917 | >25,000,000 | <97.917 |
| | | >25,000,000 | <79.167 | >25,000,000 | <97.917 | >25,000,000 | <97.917 |
| | 2.25 | >25,000,000 | <79.167 | >25,000,000 | <97.917 | >25,000,000 | <97.917 |
| | | >25,000,000 | <79.167 | >25,000,000 | <97.917 | >25,000,000 | <97.917 |
| | 2.5 | >25,000,000 | <79.167 | >25,000,000 | <97.917 | >25,000,000 | <97.917 |
| | | >25,000,000 | <79.167 | >25,000,000 | <97.917 | >25,000,000 | <97.917 |

These results indicate that, at less than pH 2.5 and, particularly less than 2.0, the antimicrobial activity of sodium acid sulfate is greatly enhanced.

Although the present invention is suitable in a wide variety of applications involving food contact disinfection, it is particularly suitable for disinfecting animal carcasses.

### Example 3

In order to test the efficacy of the composition of the present invention for use in treating animal carcasses, freshly killed whole birds were dipped and completely immersed in 13 liters of treatment solution for 10 seconds. Thereafter, the carcasses were removed and allowed to drain for 10 seconds before being placed in a 2-liter bag containing 400 milliliters of peptone solution (200 liters of peptone was poured into the bag prior to introducing the carcass, and 200 milliliters of peptone was poured into the bird cavity immediately after putting the carcass into the bag). The growth medium was 3M Aerobic Count Petrifilm. The incubation was 2-3 days at 35° C. The solutions tested were 2,000 ppm of SAS at initial pH of 1.6, 4,000 ppm of SAS at initial pH of 1.56, as well as 2,000 ppm of SAS with 600 ppm of lactic acid, 1,000 ppm of SAS with 1,200 ppm of lactic acid, and 2,400 ppm of lactic acid and 4,800 ppm of lactic acid respectively. The results of the test are shown in Table 4.

TABLE 4

| | | | Average | |
|---|---|---|---|---|
| | Weight | Organisms/ | Organisms/ | % |
| Treatment | (grams) | Bird | Bird | Reduction |
| Control - no treatment | 2528 | 1,560,000 | 2,304,000 | N/A |
| | 2306 | 4,360,000 | | |
| | 2354 | 1,320,000 | | |
| | 2106 | 2,400,000 | | |
| | 2328 | 1,880,000 | | |
| 2000 ppm SAS | 2390 | 584,000 | 576,000 | 75.0 |
| Pre 5 bird dip: pH 1.60 | 2352 | 536,000 | | |
| Post 5 bird dip: pH 1.78 | 2182 | 660,000 | | |
| | 2734 | 520,000 | | |
| | 2098 | 580,000 | | |
| 4000 ppm SAS | 2448 | 396,000 | 618,400 | 73.2 |
| Pre 5 bird dip: pH 1.56 | 2696 | 528,000 | | |
| Post 5 bird dip: pH 1.75 | 2244 | 392,000 | | |
| | 1758 | 476,000 | | |
| | 2365 | 1,300,000 | | |
| 2000 ppm SAS + 600 ppm Lactic Acid | 1998 | 1,090,000 | 1,460,400 | 36.6 |
| Pre 5 bird dip: pH 1.80 | 2188 | 376,000 | | |
| Post 5 bird dip: pH 1.94 | 1884 | 3,360,000 | | |
| | 1954 | 1,800,000 | | |
| | 2026 | 676,000 | | |
| 1000 ppm SAS + 1200 ppm Lactic Acid | 2156 | 584,000 | 576,000 | 75.0 |
| Pre 5 bird dip: pH 1.80 | 2058 | 536,000 | | |
| Post 5 bird dip: pH 1.98 | 2110 | 660,000 | | |
| | 2024 | 520,000 | | |
| | 2234 | 580,000 | | |
| 2400 ppm Lactic Acid | 2038 | 600,000 | 2,054,800 | 10.8 |
| Pre 5 bird dip: pH 1.80 | 1958 | 1,074,000 | | |
| Post 5 bird dip: pH 1.96 | 2094 | 2,120,000 | | |
| | 2070 | 3,240,000 | | |
| | 1986 | 3,240,000 | | |
| 4800 ppm Lactic Acid | 2496 | 1,000,000 | 1,430,000 | 37.9 |
| Pre 5 bird dip: pH 1.80 | 2140 | 1,800,000 | | |
| Post 5 bird dip: pH 1.96 | 2502 | 1,400,000 | | |
| | 2068 | 1,520,000 | | |

As shown in Table 4, both 2000 ppm and 4000 ppm of SAS perform well. Also, the addition of lactic acid at lower concentrations of the SAS appears to be beneficial. The lactic acid itself, however, appears to provide relatively little antimicrobial effect.

The same test was repeated using commercially available products, FreshFx C12, and Eden, comparing these with sodium acid sulfate and sodium acid sulfate in combination with citric acid. The results are shown in Table 5.

TABLE 5

| | | | Average | |
|---|---|---|---|---|
| | Weight | Organisms/ | Organisms/ | % |
| Treatment | (grams) | Bird | Bird | Reduction |
| Wash Control | 2294 | 1,720,000 | 2,176,000 | N/A |
| | 2396 | 3,800,000 | | |
| | 2982 | 3,080,000 | | |
| | 2394 | 1,000,000 | | |
| | 2472 | 1,280,000 | | |
| 1% FreshFx C12 | 2476 | 308,000 | 244,800 | 88.8 |
| | 2422 | 24,000 | | |
| | 2346 | 280,000 | | |
| | 2486 | 512,000 | | |
| | 3456 | 100,000 | | |
| 2% FreshFX C12 | 3198 | 44,000 | 111,200 | 94.9 |
| | 3106 | 52,000 | | |
| | 2292 | 392,000 | | |
| | 2476 | 20,000 | | |
| | 2950 | 48,000 | | |
| 1% Eden less | 2294 | 1,520,000 | 528,000 | 75.7 |
| surfactant | 2396 | 136,000 | | |
| | 2982 | 444,000 | | |
| | 2394 | 252,000 | | |
| | 2472 | 292,000 | | |
| 2% Eden less | 2460 | 112,000 | 120,000 | 94.5 |
| surfactant | 2656 | 176,000 | | |
| | 2090 | 88,000 | | |
| | 2706 | 124,000 | | |
| | 2134 | 100,000 | | |
| 2000 ppm SAS | 2986 | 556,000 | 246,400 | 88.7 |
| | 3362 | 128,000 | | |
| | 2032 | 264,000 | | |
| | 2218 | 88,000 | | |
| | 2410 | 196,000 | | |
| SAS and citric acid | 2764 | 588,000 | 408,000 | 81.3 |
| 2000 ppm SAS | 2596 | 416,000 | | |
| 1000 ppm Citric Acid | 2476 | 628,000 | | |
| | 2034 | LE | | |
| | 1966 | 408,000 | | |

A further embodiment of the present invention incorporates sodium acid sulfate in combination with lactic acid and citric acid. The citric acid and lactic acid appeared to enhance the activity of the sodium acid sulfate. This solution, in turn, can then be used for a direct food contact disinfectant. In such composition, the concentration of the sodium acid sulfate will be from about 0.1 to about 1.0% by weight. The concentration of the lactic acid should be from about 0.1 to about 1.0% by weight, with the concentration of the citric acid being from about 0.1 to about 1.0% by weight. Other acids that can be substituted in this composition include acetic, succinic, oxalic, tartaric, malic and alphahydroxybutyric acids. This composition can be utilized with a pH of 1.5 to 2.5, or more, particularly 1.6 to 1.8.

This can be used in any direct food contact applications, including cleaning of fruits and vegetables, animal carcasses, hard surfaces, and the like. The present invention allows the use of sodium acid sulfate in a wide variety of disinfecting applications establishing comparable efficacy to other products that are currently marketed for such applications. The present invention further has the benefit that sodium acid sulfate is a relatively mild acid, less corrosive than acids such as sulfuric, hydrochloric and nitric. Further, it does not fume, and has no significant ventilation requirements, thus making it more user friendly.

This has been a description of the present invention along with the preferred method of practicing the present invention. However, the invention itself should only be defined by the appended claims.

What is claimed is:

1. A method of disinfecting carcasses comprising coating said carcass with a solution of sodium acid sulfate wherein said solution does not include an antimicrobial effective amount of a chlorine-containing compound.

2. The method claimed in claim 1 wherein said solution is less than pH 2.5.

3. The method claimed in claim 2 wherein said solution is from about pH 1.5 to about pH 2.5.

4. The method claimed in claim 1 wherein said solution further includes a second acid selected from the group consisting of lactic acid, citric acid, and combinations thereof.

5. The method claimed in claim 5 wherein said second acid is present in an amount of from about 1,000 to about 10,000 ppm.

6. A method of cleaning a hard surface comprising applying to said surface a solution consisting essentially of sodium acid sulfate and optionally a second acid selected from the group consisting of lactic acid, citric acid and mineral acids, and combinations thereof.

7. The method claimed in claim 6 wherein said solution is from about pH 1.5 to about pH 2.5.

8. A method of cleaning a hard surface comprising applying to said surface a solution consisting of sodium acid sulfate at pH 1.5 to 2.5.

9. The method claimed in claim 1 wherein said carcass is dipped in said solution.

10. The method claimed in claim 1 wherein said carcasses are sprayed with said solution.

11. A method of cleaning produce comprising applying to said produce a solution of SAS at about pH 1.5 to about pH 2.5.

12. The method claimed in claim 11 wherein said solution further includes citric acid.

13. The method claimed in claim 12 wherein said solution further includes lactic acid

14. The method claimed in claim 11 wherein the concentration of SAS in said solution is 1,000 to 10,000 ppm.

15. The method claimed in claim 12 wherein the concentration of citric acid in said solution is 1,000 to 10,000 ppm.

16. The method claimed in claim 13 wherein the concentration of lactic acid in said solution is 1000 to 10,000 ppm.

17. A method of disinfecting the surface of an object comprising applying to a surface of said object a solution consisting essentially of SAS and optionally one or more of the following, an organic acid, a mineral acid, and a wetting agent wherein said solution is less than pH 2.25.

18. A cleaning solution comprising
1,000 to 10,000 ppm SAS;
1,000 to 10,000 ppm citric acid;
1,000 to 10,000 ppm lactic acid;
and water.
